(19) United States
(12) Patent Application Publication
(10) Pub. No.: US 2025/0327500 A1
(43) Pub. Date: Oct. 23, 2025

(54) HIGH-DAMPING STIFFNESS-VARIABLE LATTICE COMPOSITE STRUCTURE SHOCK ABSORBER, AND PREPARATION METHOD THEREFOR

(71) Applicant: SHENYANG RESEARCH INSTITUTE OF FOUNDRY CO., LTD. CAM, Tiexi District Shenyang, Liaoning (CN)

(72) Inventors: Yanpeng WEI, Tiexi District Shenyang, Liaoning (CN); Bo YU, Tiexi District Shenyang, Liaoning (CN); Jingchang CHENG, Tiexi District Shenyang, Liaoning (CN); Huaiqian LI, Tiexi District Shenyang, Liaoning (CN); Jian SHI, Tiexi District Shenyang, Liaoning (CN); Yingchun MA, Tiexi District Shenyang, Liaoning (CN); Peng GAO, Tiexi District Shenyang, Liaoning (CN); Zhiquan MIAO, Tiexi District Shenyang, Liaoning (CN); Shuwen GUAN, Tiexi District Shenyang, Liaoning (CN)

(73) Assignee: SHENYANG RESEARCH INSTITUTE OF FOUNDRY CO., LTD. CAM, Tiexi District Shenyang, Liaoning (CN)

(21) Appl. No.: 18/841,064

(22) PCT Filed: Feb. 17, 2023
(86) PCT No.: PCT/CN2023/076647

§ 371 Date: Aug. 23, 2024

(30) Foreign Application Priority Data
Jan. 3, 2023 (CN) 202310000470.7

(51) Int. Cl. F16F 3/10; B22F 10/28; B22F 10/64; B22F 10/66; B33Y 10/00; B33Y 40/20; B33Y 80/00; C08K 3/34; C08K 5/12; C09D 7/20; C09D 7/40; C09D 7/61; C09D 7/63; C09D 163/00; C09D 175/04

(52) U.S. Cl. CPC F16F 3/10; B33Y 80/00; C09D 7/20; C09D 7/61; C09D 7/63; C09D 7/67; C09D 163/00; C09D 175/04; B22F 10/28; B22F 10/64; B22F 10/66; B33Y 10/00; B33Y 40/20; C08K 3/34; C08K 5/12; C08K 2201/011; F16F 2224/0208; F16F 2224/0275; F16F 2226/04; F16F 2228/066

(57) ABSTRACT

A high-damping stiffness-variable lattice composite structure shock absorber, and a preparation method therefor. The shock absorber is composed of a lattice composite structure and a base, wherein the lattice composite structure is formed by compositing a lattice metal and a viscoelastic material. The adjustment and control range of the porosity of the lattice metal is 30-90%; the hole edge diameter of the lattice metal is 1-3 mm; and the minimum hole diameter is 0.8-2.5 mm. The matrix material of the lattice metal is a steel material; and the matrix material of the viscoelastic material is an epoxy resin or polyurethane.

### TECHNICAL FIELD

The present disclosure belongs to the field of shock absorbers, and in particular provides a high-damping stiffness-variable lattice composite structure shock absorber and a manufacturing method thereof.

### BACKGROUND

Vibration and noise reduction of high-end facilities such as aeronautics or aerospace vehicles and ships is an urgent technical problem to be solved. As equipment becomes more and more high-speed and automatic, it also brings ubiquitous noise and vibration problems. In the long run, the precision of the equipment will be reduced, and the staff will feel agitated, which seriously affect their physical and mental health. Therefore, vibration and noise reduction has become a key technical bottleneck for manufacturing high-end facilities for high-efficiency service.

The connection between the equipment and the hull is usually classified into elastic connection or rigid connection. Elastic connection mainly means that the equipment is installed on a shock absorber of viscoelastic material and is connected with the hull through the shock absorber. With elastic connection, the effect of vibration and noise reduction is obvious, but there are problems such as too low stiffness and too high vibration intensity of the equipment installed on the shock absorber, and there are great safety risks. In addition, viscoelastic materials such as rubber are easy to age and need to be replaced frequently, which increases the operation and maintenance cost of equipment. Rigid connection means that no shock absorber is installed, and the equipment is directly connected with the hull by fasteners such as bolts. This connection pattern has the advantages of low vibration intensity of the equipment and high safety. However, rigid connection continuously transmits the vibration and noise away through the hull and has almost no ability to reduce the vibration and noise. Therefore, it is of great engineering value to find a shock absorber with a stiffness between that of elastic connection and that of rigid connection, and with high damping characteristics for improving the overall level of vibration and noise reduction of the facilities.

Lattice metal has characteristics of freely adjustable porosity and freely designable pore structure. It is possible to design a lattice structure shock absorber with a stiffness between that of elastic connection and that of rigid connection and realize the design of a stiffness-variable lattice structure shock absorber by adjusting and controlling the porosity. In addition, viscoelastic material is infiltrated into the lattice structure shock absorber to manufacture a high-damping lattice composite structure shock absorber, which leads to a better solution for vibration and noise reduction of high-end facilities such as ships. However, problems including poor interface bonding between the viscoelastic material and the metal, the difficulty of filling viscoelastic material into the lattice metal with small pore diameters through infiltration, and easy generation of bubbles due to insufficient infiltration deteriorate the performance of the materials, and there is still a big gap from practical application.

### SUMMARY

In order to solve the problems in the existing art, the present disclosure provides a high-damping stiffness-variable lattice composite structure shock absorber and a manufacturing method thereof.

According to an aspect of the present disclosure, a stiffness-variable lattice structure shock absorber is designed through effective adjustment and control of pore shape parameters, porosity and pore diameter of the lattice structure.

In particular, a high-damping stiffness-variable lattice composite structure shock absorber is provided, and the shock absorber is composed of a lattice composite structure and a base; the lattice composite structure is formed by compositing a lattice metal and a viscoelastic material; the adjustment and control range of the porosity of the lattice metal is 30˜90%, the linkage diameter of the lattice metal is 1˜3 mm, and the minimum pore diameter of the lattice metal is 0.8˜2.5 mm; the matrix material of the lattice metal is a steel material, and the matrix material of the viscoelastic material is epoxy resin or polyurethane.

As preferred technical solutions:

The cell pore structure of the lattice metal is a BCC structure or a Kelvin structure.

The model of the epoxy resin is E44 and/or E51, and for every 100 portions by weight of the epoxy resin, 25˜35 portions by weight of curing agent, 5˜20 portions by weight of toughening agent and 5˜20 portions by weight of reactive diluent need to be added, and the viscosity of the obtained epoxy resin-based viscoelastic material at room temperature is controlled at 200˜10000 mPa·s; the curing agent is preferably T31 curing agent, the toughening agent is preferably dibutyl phthalate, and the reactive diluent is preferably glycol diglycidyl ether. The curing agent can let the epoxy resin completely cure, while too little curing agent cannot achieve curing of the epoxy resin, and too much curing agent will easily make the epoxy resin brittle, which is not conducive to the damping performance; the toughening agent can enhance the toughness of the resin system; the reactive diluent controls the viscosity of the system by participating in the reaction.

The manufacturing method of the viscoelastic material with polyurethane as the matrix material is as follows: heating polyurethane particles to 120˜160° C., adding acetone as diluent after the polyurethane particles melt, and the addition amount of acetone is 5˜30 portions by weight of acetone per 100 portions by weight of polyurethane particles, so as to manufacture the polyurethane-based viscoelastic material.

The viscoelastic material further contains nano-scale SiC to improve the damping performance, and the addition amount of the nano-scale SiC is 0.5˜5 wt. % of the viscoelastic material. The nano-scale SiC is light, can be uniformly dispersed, and effectively improves the damping performance of the material.

The above two types of viscoelastic materials can ensure the bonding strength of the interface with metal materials, and allows the viscoelastic materials to infiltrate into the lattice metal with small pores.

According to another aspect of the present disclosure, through designing the proportioning and the infiltration process of the viscoelastic material, the interface wettability and the interface bonding strength between the viscoelastic material and the lattice metal are improved, and the viscoelastic material is allowed to effectively fill inside the lattice metal with small pore sizes, eliminating defects such as bubbles at the interface and inside the viscoelastic material, and finally, a high-damping stiffness-variable lattice composite structure shock absorber is obtained in which the interface bonding between the viscoelastic material and the metal is tight, the lattice metal is fully filled inside with no bubbles present.

In particular, a method for manufacturing a high-damping stiffness-variable lattice composite structure shock absorber is provided, which includes the following specific steps.
Step 1, designing lattice metal by three-dimensional design software, manufacturing the lattice metal by selective laser melting additive manufacturing process, and performing heat treatment on the lattice metal, the process of the heat treatment includes: heating to 1050˜1080° C., keeping the temperature for 30˜120 min, water cooling, and the heating is performed at a rate of 5˜20° C./min; after the heat treatment, removing oxide layer by sandblasting, and then removing surface dirt by ultrasonic cleaning;
Step 2, preparing the viscoelastic material according to different processes, and after the preparation is completed, for epoxy resin-based viscoelastic material, heating the viscoelastic material to 80˜120° C. for electromagnetic stirring and ultrasonic vibration, and for polyurethane-based viscoelastic material, heating the viscoelastic material to 120˜160° C. for electromagnetic stirring and ultrasonic vibration;
Step 3, immediately filling the viscoelastic material evenly mixed in step 2 into the lattice metal through natural infiltration, performing vacuuming to −10⁻²˜−10⁻¹ Pa at the filling temperature, keeping for 30˜60 min, and obtaining a lattice composite structure through curing, assembling the lattice composite structure with the base to form the high-damping stiffness-variable lattice composite structure shock absorber.

As preferred technical solutions:
In step 3, the lattice metal is preheated before the filling, and the preheating temperature is the same as the heating temperature of the corresponding viscoelastic material in step 2; the curing process of the epoxy resin-based viscoelastic material is: keeping at 50˜80° C. for 30˜60 min, and then curing at room temperature; the curing process of the polyurethane-based viscoelastic material is: drying in a vacuum drying box below 50° C.

The lattice composite structure shock absorber manufactured by the method of the present disclosure has characteristics of high damping and variable stiffness, the damping ratio of which is higher than 10%, and the stiffness can be freely adjusted in a range of 69˜276 kN/mm. The shock absorber can be used as a vibration and noise transmission path component in the fields of aeronautics and aerospace, ships and precision instruments.

The present disclosure has following advantages and beneficial effects.
1) In the present disclosure, by means of effective adjustments and control of the pore shape parameters and the porosity of the lattice structure, the stiffness of the lattice structure shock absorber is adjusted between that of an elastic connection and that of a rigid connection, so that the shortcomings of the elastic connection and the rigid connection are overcome. The lattice composite structure shock absorber according to the present disclosure has the characteristic of variable stiffness.
2) In the present disclosure, the lattice structure shock absorber is filled with the viscoelastic material by means of infiltration and vacuum auxiliary technology, and by means of material modification and process adjustments and control, so that the key problems of poor interface bonding of the viscoelastic material to the metal, lattice metal being insufficiently infiltrated with the viscoelastic material, and bubbles being prone to being generated inside the viscoelastic material and at the interface between the viscoelastic material and the metal are solved. The developed high-damping stiffness-variable lattice composite structure shock absorber has broad application prospects in vibration and noise transmission paths in the fields of aeronautics and aerospace, ships, precision instruments and the like.

### BRIEF DESCRIPTION OF THE DRAWINGS

FIG. 1 is a schematic structural diagram of a BCC cell of the lattice composite structure shock absorber.

FIG. 2 is a schematic structural diagram of the lattice metal of the lattice composite structure shock absorber.

FIG. 3 is a schematic diagram of the lattice composite structure with epoxy resin as the filler.

FIG. 4 is a schematic structural diagram of a lattice composite structure shock absorber with BCC cells without adding skin.

FIG. 5 is a schematic structural diagram of a lattice composite structure shock absorber with BCC cells with skin added.

FIG. 6 is a schematic structural diagram of a lattice composite structure shock absorber with Kelvin cells without adding skin.

### DETAILED DESCRIPTION OF THE EMBODIMENTS

The shock absorbers in the embodiments are each composed of a lattice composite structure and a base, and bolt holes are provided at the top of the lattice composite structure and at the base, so as to realize the fixation and installation of the equipment. The lattice composite structure is formed by compositing a lattice metal and a viscoelastic material. The pore structure of the cell of the lattice metal can be designed freely.

### Embodiment One

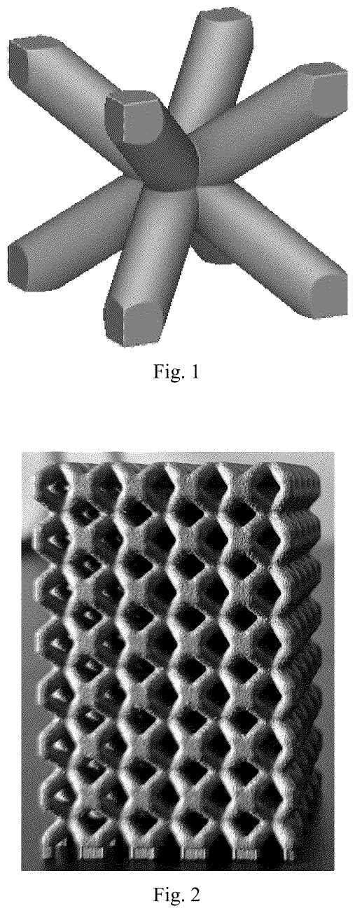

For BCC lattice metal, the material used is 316L metal powder, and the cell structure of the lattice metal is shown in FIG. 1, with porosity of 30%, linkage diameter of 1 mm and minimum pore diameter of 0.8 mm. The schematic structural diagram of the lattice metal is shown in FIG. 2.

For the viscoelastic material, the matrix material is E44 epoxy resin, and the specific proportion by mass is: 100 portions of epoxy resin, 25 portions of T31 curing agent, 5 portions of dibutyl phthalate as toughening agent, 0.1 portion of 50 nm SiC inorganic filler and 5 portions of glycol diglycidyl ether as reactive diluent. The viscosity of the obtained epoxy resin-based viscoelastic material at room temperature is 10000 mPa·s.

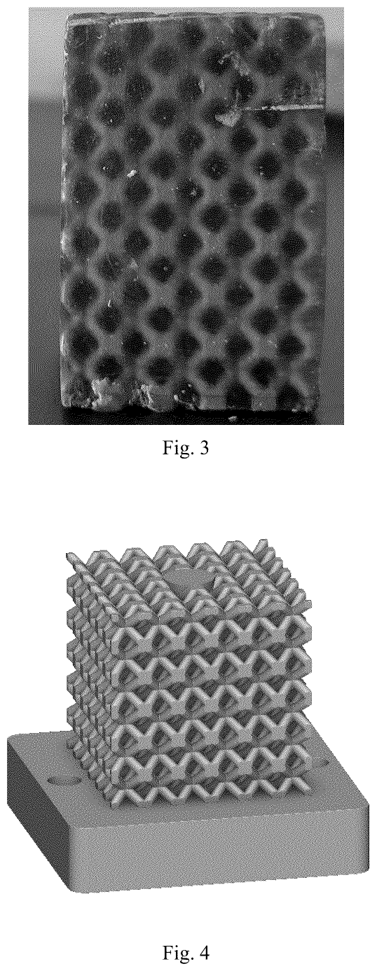

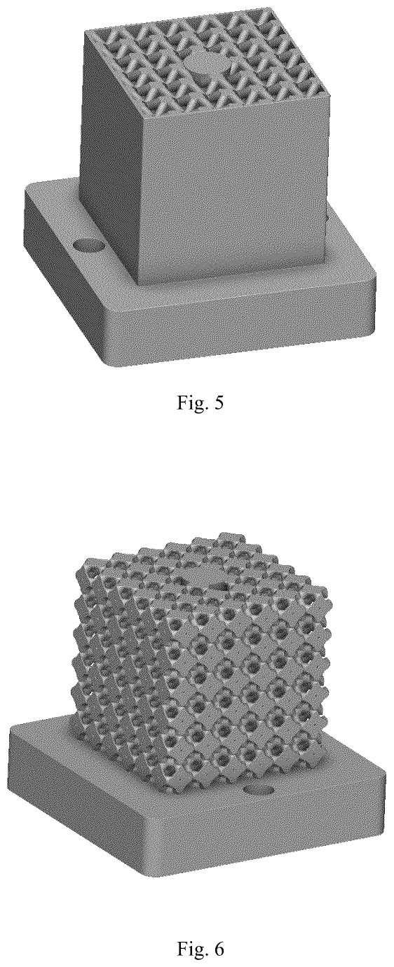

The steps for manufacturing the high-damping stiffness-variable lattice composite structure shock absorber are as follows.
Step 1, designing the lattice metal by three-dimensional design software, manufacturing the lattice metal by selective laser melting additive manufacturing process, and performing heat treatment on the lattice metal, the process of heat treatment is: heating to 1050° C. with a heating rate of 5° C./min, keeping the temperature for 30 min, and cooling with water. The surface oxide layer is removed by sandblasting, and the surface dirt is removed by ultrasonic cleaning.
Step 2, preparing the viscoelastic material, and mixing the viscoelastic material evenly by electromagnetic stirring and ultrasonic vibration at 80° C.
Step 3, infiltrating the viscoelastic material into the lattice metal preheated to 80° C., keeping the lattice metal with the viscoelastic material in a vacuum environment of −10⁻¹ Pa for 30 min, then drying it at 50° C. for 60 min, taking it out and curing it at room temperature for 12 h, so as to obtain a lattice composite structure as shown in FIG. 3. By combining the lattice composite structure with the base, a high-damping stiffness-variable lattice composite structure shock absorber is obtained, with damping ratio of 0.12, stiffness of 276 kN/mm, high interface bonding strength and no bubbles in the viscoelastic material or at the bonded interface. For example, FIG. 4 is a schematic structural diagram of a lattice composite structure shock absorber with BCC cells without adding skin. For example, FIG. 5 is a schematic structural diagram of a lattice composite structure shock absorber with BCC cells with skin added.

### Comparative Example One

This example is a comparative example of embodiment one, with the difference that the proportion by mass for the viscoelastic material is: 100 portions of epoxy resin, 40 portions of T31 curing agent, 5 portions of dibutyl phthalate as toughening agent, 0.1 portion of 50 nm SiC inorganic filler and 5 portions of glycol diglycidyl ether as reactive diluent. The viscosity of the obtained epoxy resin-based viscoelastic material at room temperature is 500 mPa·s.

The damping ratio of the obtained lattice composite structure shock absorber is 0.05, which damping ratio is lower than 0.1 and cannot meet the performance requirements.

### Comparative Example Two

This example is a comparative example of embodiment one, and the difference is that the viscoelastic material is not subjected to electromagnetic stirring and ultrasonic vibration, and is directly infiltrated into the lattice metal without vacuum treatment. The obtained lattice composite structure has a low filling ratio and cannot be fully filled.

### Embodiment Two

For Kelvin structure lattice metal, the material used is 316L metal powder, with porosity of 60%, linkage diameter of 2 mm and minimum pore diameter of 1.8 mm.

For the viscoelastic material, the matrix material is mixed resin with 50 wt. % of E44 epoxy resin and 50 wt. % of E51 epoxy resin, and the specific proportion by mass is: 100 portions of the mixed resin, 30 portions of T31 curing agent, 10 portions of dibutyl phthalate as toughening agent, 3 portions of 50 nm SiC inorganic filler and 10 portions of glycol diglycidyl ether as reactive diluent. The viscosity of the obtained epoxy resin-based viscoelastic material at room temperature is 3000 mPa·s.

The steps for manufacturing the shock absorber with high damping, variable stiffness and a lattice composite structure are as follows.
Step 1, designing lattice metal by three-dimensional design software, manufacturing the lattice metal by selective laser melting additive manufacturing process, and performing heat treatment on the lattice metal, the process of heat treatment is: heating to 1080° C. with a heating rate of 10° C./min, keeping the temperature for 90 min, and cooling with water. The surface oxide layer is removed by sandblasting, and the surface dirt is removed by ultrasonic cleaning.
Step 2, preparing the viscoelastic material, and mixing the viscoelastic material evenly by electromagnetic stirring and ultrasonic vibration at 100° C.
Step 3, infiltrating the viscoelastic material into the lattice metal preheated to 100° C., keeping the lattice metal with the viscoelastic material in a vacuum environment of −10⁻² Pa for 60 min, then subjecting it to a vacuum environment of −10⁻² Pa for 30 min, then drying it at 70° C. for 40 min, taking it out and curing it at room temperature for 12 h, By combining the lattice composite structure with the base, a high-damping stiffness-variable lattice composite structure shock absorber is obtained, with damping ratio of 0.15, stiffness of 150 kN/mm, high interface bonding strength and no bubbles in the viscoelastic material or at the bonded interface. For example, FIG. 6 is a schematic structural diagram of a lattice composite structure shock absorber with Kelvin cells without adding skin.

### Embodiment Three

For BCC lattice metal, the material used is 316L metal powder, with porosity of 90%, linkage diameter of 3 mm and minimum pore diameter of 2.5 mm.

For the viscoelastic material, the matrix material is E51 epoxy resin, and the specific proportion by mass is: 100 portions of epoxy resin, 35 portions of T31 curing agent, 20 portions of dibutyl phthalate as toughening agent, 5 portions of 50 nm SiC inorganic filler and 20 portions of glycol diglycidyl ether as reactive diluent. The viscosity of the obtained epoxy resin-based viscoelastic material at room temperature is 200 mPa·s.

The steps for manufacturing the shock absorber with high damping, variable stiffness and a lattice composite structure are as follows.
Step 1, designing lattice metal by three-dimensional design software, manufacturing the lattice metal by selective laser melting additive manufacturing process, and performing heat treatment on the lattice metal, the process of heat treatment is: heating to 1050° C. with a heating rate of 20° C./min, keeping the temperature for 120 min, and cooling with water. The surface oxide layer is removed by sandblasting, and the surface dirt is removed by ultrasonic cleaning.
Step 2, preparing the viscoelastic material, and mixing the viscoelastic material evenly by electromagnetic stirring and ultrasonic vibration at 120° C.
Step 3, infiltrating the viscoelastic material into the lattice metal preheated to 120° C., keeping the lattice metal with the viscoelastic material in a vacuum environment of −10¹ Pa for 30 min, then drying it at 80° C. for 30 min, taking it out and curing it at room temperature for 12 h. By combining the lattice composite structure with the base, a high-damping stiffness-variable lattice composite structure shock absorber is obtained, with damping ratio of 0.14, stiffness of 69 kN/mm, high interface bonding strength and no bubbles in the viscoelastic material or at the bonded interface.

### Embodiment Four

For BCC lattice metal, the material used is 316L metal powder, with porosity of 30%, linkage diameter of 1 mm and minimum pore diameter of 0.8 mm.

For the viscoelastic material, the matrix material is polyurethane. Polyurethane particles are melted at 120° C., and 30 wt. % of acetone as diluent and 0.1 wt. % of 50 nm SiC inorganic filler are added.

The steps for manufacturing the high-damping stiffness-variable lattice composite structure shock absorber are as follows.
Step 1, designing lattice metal by three-dimensional design software, manufacturing the lattice metal by selective laser melting additive manufacturing process, and performing heat treatment on the lattice metal, the process of heat treatment is: heating to 1080° C. with a heating rate of 5° C./min, keeping the temperature for 30 min, and cooling with water. The surface oxide layer is removed by sandblasting, and the surface dirt is removed by ultrasonic cleaning.
Step 2, preparing the viscoelastic material, and mixing the viscoelastic material evenly by electromagnetic stirring and ultrasonic vibration at 120° C.
Step 3, infiltrating the viscoelastic material into the lattice metal preheated to 120° C., keeping the lattice metal with the viscoelastic material in a vacuum environment of −10⁻² Pa for 30 min, then curing it at 50° C. for 5 h. By combining the lattice composite structure with the base, a high-damping stiffness-variable lattice composite structure shock absorber is obtained, with damping ratio of 0.15, stiffness of 276 kN/mm, high interface bonding strength and no bubbles in the viscoelastic material or at the bonded interface.

### Comparative Example Three

This example is a comparative example of embodiment four. In this example, polyurethane particles are melted at 100° C., and 30 wt. % of diluent and 0.1 wt. % of 50 nm SiC inorganic filler are added, and then they are evenly mixed by electromagnetic stirring and infiltrated into the lattice metal preheated to 100° C. At 100° C., the fluidity of the polyurethane is poor, and only some of the regions can be filled.

### Comparative Example Four

This example is a comparative example of embodiment four. In this example, the material used is 316L metal powder, and BCC lattice metal with porosity of 30% is manufactured, with linkage diameter of 1 mm, minimum pore diameter of 0.8 mm, and stiffness of 276 kN/mm. The process of heat treatment is: heating to 1050° C. with a heating rate of 5° C./min, keeping the temperature for 30 min, and cooling with water. Polyurethane particles are melted at 120° C., and 30 wt. % of diluent and 0.1 wt. % of 50 nm SiC inorganic filler are added, and then they are evenly mixed by electromagnetic stirring and infiltrated into the lattice metal preheated to 120° C. and cured at 50° C. for 5 h without vacuum treatment. There are bubbles at the interface, and the interface bonding is not good.

### Embodiment Five

For BCC lattice metal, the material used is 316L metal powder, with porosity of 60%, linkage diameter of 2 mm and minimum pore diameter of 1.8 mm.

For the viscoelastic material, the matrix material is polyurethane. Polyurethane particles are melted at 140° C., and 15 wt. % of acetone as diluent and 3 wt. % of 50 nm SiC inorganic filler are added.

The steps for manufacturing the high-damping stiffness-variable lattice composite structure shock absorber are as follows.
Step 1, designing lattice metal by three-dimensional design software, manufacturing the lattice metal by selective laser melting additive manufacturing process, and performing heat treatment on the lattice metal, the process of heat treatment is: heating to 1050° C. with a heating rate of 10° C./min, keeping the temperature for 90 min, and cooling with water. The surface oxide layer is removed by sandblasting, and the surface dirt is removed by ultrasonic cleaning.
Step 2, preparing the viscoelastic material, and mixing the viscoelastic material evenly by electromagnetic stirring and ultrasonic vibration at 140° C.
Step 3, infiltrating the viscoelastic material into the lattice metal preheated to 140° C., keeping the lattice metal with the viscoelastic material in a vacuum environment of −10⁻² Pa for 60 min, then curing it at 40° C. for 5 h. By combining the lattice composite structure with the base, a high-damping stiffness-variable lattice composite structure shock absorber is obtained, with damping ratio of 0.16, stiffness of 150 kN/mm, high interface bonding strength and no bubbles in the viscoelastic material or at the bonded interface.

### Embodiment Six

For BCC lattice metal, the material used is 316L metal powder, with porosity of 90%, linkage diameter of 3 mm and minimum pore diameter of 2.5 mm.

For the viscoelastic material, the matrix material is polyurethane. Polyurethane particles are melted at 160° C., and 5 wt. % of acetone as diluent and 5 wt. % of 50 nm SiC inorganic filler are added.

The steps for manufacturing the high-damping stiffness-variable lattice composite structure shock absorber are as follows.
Step 1, designing lattice metal by three-dimensional design software, manufacturing the lattice metal by selective laser melting additive manufacturing process, and performing heat treatment on the lattice metal, the process of heat treatment is: heating to 1050° C. with a heating rate of 20° C./min, keeping the temperature for 120 min, and cooling with water. The surface oxide layer is removed by sandblasting, and the surface dirt is removed by ultrasonic cleaning.
Step 2, preparing the viscoelastic material, and mixing the viscoelastic material evenly by electromagnetic stirring and ultrasonic vibration at 160° C.
Step 3, infiltrating the viscoelastic material into the lattice metal preheated to 160° C., keeping the lattice metal with the viscoelastic material in a vacuum environment of −10⁻² Pa for 30 min, then curing it at 30° C. for 4 h. By combining the lattice composite structure with the base, a high-damping stiffness-variable lattice composite structure shock absorber is obtained, with damping ratio of 0.18, stiffness of 69 kN/mm, high interface bonding strength and no bubbles in the viscoelastic material or at the bonded interface.

Matters not covered in the present disclosure are known in the existing art.

Although the present disclosure has been described with reference to the explanatory embodiments thereof, the embodiments of the present disclosure are not limited by the above embodiments. It should be understood that many other modifications and embodiments can be designed by those skilled in the art, which will fall within the scope and spirit of the principles disclosed in this application.

1-6. (canceled)

7. A method for manufacturing a high-damping stiffness-variable lattice composite structure shock absorber, wherein the method comprises the following steps:
step 1, designing the lattice metal by three-dimensional design software, manufacturing the lattice metal by selective laser melting additive manufacturing process, and performing heat treatment on the lattice metal, wherein a process of the heat treatment comprises: heating to 1050˜1080° C., keeping the temperature for 30˜120 min, water cooling, wherein the heating is performed at a rate of 5˜20° C./min; after the heat treatment, removing oxide layer by sandblasting, and then removing surface dirt by ultrasonic cleaning;
step 2, preparing the viscoelastic material according to different processes, and after the preparation is completed, for epoxy resin-based viscoelastic material, heating the viscoelastic material to 80˜120° C. for electromagnetic stirring and ultrasonic vibration, and for polyurethane-based viscoelastic material, heating the viscoelastic material to 120˜160° C. for electromagnetic stirring and ultrasonic vibration;
step 3, immediately filling the viscoelastic material evenly mixed in step 2 into the lattice metal through natural infiltration, performing vacuuming to −10-2˜−10-1 Pa at the filling temperature, keeping for 30˜60 min, and obtaining a lattice composite structure through curing, assembling the lattice composite structure with the base to form the high-damping stiffness-variable lattice composite structure shock absorber,
wherein a model of the epoxy resin is E44 and/or E51, and for every 100 portions by weight of the epoxy resin, 25˜35 portions by weight of curing agent, 5˜20 portions by weight of toughening agent and 5˜20 portions by weight of reactive diluent need to be added, and a viscosity of an obtained epoxy resin-based viscoelastic material at room temperature is controlled at 200˜10000 mPa·s, wherein the heating temperature of the epoxy resin is 80° C., 100° C. or 120° C.,
wherein a method for manufacturing the viscoelastic material with polyurethane as the matrix material is as follows: heating polyurethane particles to 120˜160° C., adding acetone as diluent after the polyurethane particles melt, wherein an addition amount of acetone is 5˜30 portions by weight of acetone per 100 portions by weight of polyurethane particles, so as to manufacture a polyurethane-based viscoelastic material, and
wherein in step 3, the lattice metal is preheated before the filling, and a preheating temperature is the same as a heating temperature of the corresponding viscoelastic material in step 2: the curing process of the epoxy resin-based viscoelastic material is: keeping at 50˜80° C. for 30˜60 min, and then curing at room temperature: the curing process of the polyurethane-based viscoelastic material is: drying in a vacuum drying box below 50° C.

8. (canceled)

9. The method for manufacturing a high-damping stiffness-variable lattice composite structure shock absorber according to claim 7, wherein the high-damping stiffness-variable lattice composite structure shock absorber has a damping ratio higher than 10%, and a stiffness freely adjustable in a range of 69˜276 kN/mm.

10. (canceled)

11. A high-damping stiffness-variable lattice composite structure shock absorber manufactured according to the method of claim 7, wherein the shock absorber is composed of a lattice composite structure and a base; the lattice composite structure is formed by compositing a lattice metal and a viscoelastic material, wherein an adjustment and control range of a porosity of the lattice metal is 30˜90%, a minimum pore diameter the lattice metal is 0.8˜2.5 mm, a linkage diameter of the lattice metal is 1˜3 mm, a matrix material of the lattice metal is a steel material, and a matrix material of the viscoelastic material is epoxy resin or polyurethane.

12. The high-damping stiffness-variable lattice composite structure shock absorber according to claim 11, wherein the cell pore structure of the lattice metal is a BCC structure or a Kelvin structure.

13. The high-damping stiffness-variable lattice composite structure shock absorber according to claim 11, wherein the curing agent is T31 curing agent, the toughening agent is dibutyl phthalate, and the reactive diluent is glycol diglycidyl ether.

14. The high-damping stiffness-variable lattice composite structure shock absorber according to claim 11, wherein the viscoelastic material further contains nano-scale SiC to improve damping performance, and an addition amount of the nano-scale SiC is 0.5˜5 wt. % of the viscoelastic material.

15. Use of the high-damping stiffness-variable lattice composite structure shock absorber according to claim 11 as a vibration and noise transmission path component in fields of aeronautics and aerospace, ships and precision instruments.
